(19) United States
(12) Patent Application Publication
(10) Pub. No.: US 2020/0260742 A1
(43) Pub. Date: Aug. 20, 2020

(54) METHOD FOR USING LEFTOVER ICE-CREAM BY MIXING THE ICE-CREAM WITH FLOUR AND YEAST, AND BAKERY PRODUCTS HAVING VARIOUS FLAVOURS OBTAINED WITH SAID MIXTURES

(71) Applicant: RACCA STUDIOS S.r.l.s., Imperia (IT)

(72) Inventor: Alessandro Racca, Imperia (IT)

(21) Appl. No.: 16/787,752

(22) Filed: Feb. 11, 2020

(30) Foreign Application Priority Data
Feb. 14, 2019 (IT) 102019000002179

(51) Int. Cl. A21D 10/00; A21D 8/06

(52) U.S. Cl. CPC A21D 10/002; A21D 8/06

(57) ABSTRACT

A method for using leftover ice-cream to produce bakery products such as croissants, brioches, doughnuts or similar characterized in that leftover ice-cream, as a liquid component, is added to a basic mixture of yeast and flour, resulting in the formation of a leavened floury dough suitable for oven baking.

### CROSS-REFERENCE TO RELATED APPLICATIONS

The present application claims priority to Italian Patent Application No. 102019000002179 filed on Feb. 14, 2019, the entirety of the disclosure of which is expressly incorporated herein by reference.

### STATEMENT RE: FEDERALLY SPONSORED RESEARCH/DEVELOPMENT

Not Applicable

### BACKGROUND

The present invention concerns a mixture for leavened bakery products, such as croissants or similar pastry products, in which the liquid component of the mixture partially or totally consists of ice-cream or ice-cream blend.

This ensures total utilization of the ice-cream, obtaining innovative bakery products which have the flavour of the ice-cream (chocolate, vanilla etc.), while maintaining the fragrance, fluffiness, crispness and organoleptic properties of the product in addition to performing better in terms of proofing, appetisability and conservation.

### BRIEF SUMMARY

It is known that in ice-cream parlours, at the end of the day, there is a considerable amount of leftover ice-cream. These leftovers have limited conservation times, and are often thrown away. The aim of the present invention is therefore to use these leftovers as a liquid component in a flour and yeast mixture to create bakery products such as croissants, brioches and/or similar products.

### DETAILED DESCRIPTION

The invention not only ensures utilization of this leftover ice-cream, which would usually be discarded, but bakery products are obtained having healthy, totally natural and appetising flavours which are completely new due to the ice-cream flavours used; furthermore, this method increases the customer footfall in the ice-cream parlour since customers have many different products to choose from.

A further advantage of the process according to the present invention consists in the fact that it controls the temperature of the mixture which, during the mechanical processing, is increased by the friction produced by the mixers. The gluten formation is also controlled due to the low temperature of the mixture, so that the starch is not able to hydrate completely and the protein part prevails, assisted by the hydrocolloids naturally occurring in the ice-cream, and therefore also in the mixture.

Some practical examples of recipes according to the invention are given below.

### EXAMPLE OF BASIC MIXTURE

Basic Mixture for Natural Yeast Croissants

| | | |
|---|---|---|
| Sourdough | g | 400 |
| Croissant flour 340/360W | g | 1600 |
| Fresh butter 82% fat | g | 150 |
| Sugar | g | 300 |
| Eggs | g | 250 |
| Powdered low-fat milk | g | 50 |
| Salt | g | 25 |
| Malt | g | 2 |
| Water | g | 520 |
| Powdered Madagascar vanilla | g | 8 |
| Total | g | 3300 |

### EXAMPLE 1

Approximately 1250 grams of cream flavoured ice-cream are added to a mixture of sourdough, croissant flour, salt and malt as above, replacing the butter, sugar, eggs, powdered low-fat milk, water and vanilla.

| | | |
|---|---|---|
| Sourdough | g | 400 |
| Croissant flour 340/360W | g | 1600 |
| VANILLA ICE-CREAM | g | 1250 |

Furthermore, thanks to the addition of the ice-cream, the mixture is enriched with carob seed flour, guar gum and tara gum which will improve the performance of the mixture.

Mix for 20′ until fully blended.

Final temperature of the mixture 20°-22° C.

Leave to rest at ambient temperature for at least 1.5 hours, keep in the refrigerator at +4° C. for 12 hours.

Sheet and divide into portions as required with 1000 g of butter, performing three 3-folds.

Place in a retarder-proofer for at least 12 hours at 26° C.

Bake at 200° C. in a static oven for 14/16′ or fan oven at 180° C. for 12/13′.

### EXAMPLE 2

Chocolate Croissants (No Eggs)

| | | |
|---|---|---|
| Wholemeal croissant flour 340W | g | 1500 |
| Milk chocolate ice-cream | g | 800 |
| Salt | g | 20 |
| Powdered brewer's yeast | g | 10 |
| Total | g | 2330 |

Mix for 20′ until fully blended.

Final temperature of the mixture 20°-22° C.

Leave to rest at ambient temperature for at least 2 hours, keep in the refrigerator at +4° C.

Sheet and divide into portions as required with 500 g of butter, performing two 4-folds.

Place in a retarder-proofer for at least 12 hours at 26° C.

Bake at 200° C. in a static oven for 14/16′ or a fan oven at 180° C.

### EXAMPLE 3

### Pistachio Doughnuts

| | | |
|---|---|---|
| Croissant flour | g | 1500 |
| Pistachio ice-cream | g | 1000 |
| Salt | g | 20 |
| Powdered brewer's yeast | g | 10 |
| Total | g | 2530 |

Mix for 20′ until fully blended.

Final temperature of the mixture 20°-22° C.

Leave to rest at ambient temperature for at least 2 hours, keep in the refrigerator at +4° C.

Divide into portions as required and fry in olive oil at 175° C./180° C.

Fill with confectioner's custard or spreadable pistachio cream.

The balance of the recipe is obtained as follows:

weight of the ice-cream−total ice-cream solids=weight of the water contained in the ice-cream

from which 15% is subtracted (mean % of the water bound with solid material of the ice-cream mixture).

The above value is multiplied ×2 and the quantity of flour to be used is obtained.

Other products are added, if necessary, to the flour and the ice-cream according to the recipe/finished product required.

Naturally the present invention is not limited to the above recipe examples, but comprises all possible variations to a mixture of ice-cream with flour and yeast, as claimed in the attached claims.

What is claimed is:

1) A method for using leftover ice-cream with the production of bakery products such as croissants, brioches, doughnuts or similar characterized by the following operative phases:
formation of a sourdough, croissant flour, salt and malt mixture by addition of 1,600 grams of croissant flour 340/360 W and 1,250 grams of ice-cream to 400 grams of sourdough;
mixing for 20′ until fully blended, bringing the final temperature of the mixture to 20-22 degrees C.;
leaving to rest at ambient temperature for at least 1.5 hours, keeping in the refrigerator at plus 4 degrees C. for 12 hours;
sheeting and portioning as required with 1,000 grams of butter;
placing in a retarder-proofer for at least 12 hours at 26 degrees C.;
baking at 200 degrees C. in a static oven for 14/16′ or fan oven at 180 degrees C. for 12/13′.

2) The method according to claim 1, characterized in that the addition of ice-cream to the mixture wholly or partly replaces the quantity of sugar, milk and eggs.

3) The method according to claim 1, characterized in that due to the addition of ice-cream to the mixture, the latter is enriched with thickeners and emulsifiers such as carob seed flour, guar gum and tara gum.

4) The method according to claim 1, characterized in that due to the low temperature of the ice-cream present in the mixture, the temperature of the mixture is kept under control.

5) A bakery product such as croissants, brioches, doughnuts or similar obtained with the method according to claim 1 characterized in that it is flavoured with the flavour of the ice-cream used in the mixture.

6) A chocolate croissant obtained by means of a mixture of:

| | | |
|---|---|---|
| Wholemeal CROISSANT flour 340W | g | 1500 |
| Milk chocolate ice-cream | g | 800 |
| Salt | g | 20 |
| Powdered brewer's yeast | g | 10 |
| Total | g | 2330 |

Mix for 20′ until fully blended.
Final temperature of the mixture 20° C.-22° C.
Leave to rest at ambient temperature for at least 2 hours, keep in the refrigerator at +4° C.
Sheet and portion as required with 500 g of butter, performing two 4-folds.
Place in a retarder-proofer for at least 12 hours at 26° C.
Bake at 200° C. in a static oven for 14/16′ or in a fan oven at 180° C.

7) Pistachio doughnut obtained from a mixture of:

| | | |
|---|---|---|
| CROISSANT flour | g | 1500 |
| Pistachio ice-cream | g | 1000 |
| Salt | g | 20 |
| Powdered brewer's yeast | g | 10 |
| Total | g | 2530 |

Mix for 20′ until fully blended.
Final temperature of the mixture 20° C.-22° C.
Leave to rest at ambient temperature for at least 2 hours, keep in the refrigerator at +4° C.
Portion as required and fry in olive oil at 175° C./180° C.
Fill with confectioner's custard or spreadable pistachio cream.
